(19) United States
(12) Patent Application Publication
(10) Pub. No.: US 2026/0071600 A1
(43) Pub. Date: Mar. 12, 2026

(54) APPARATUS AND METHOD FOR CONTROLLING FUEL FILTER HEATER OF VEHICLE

(71) Applicants: HYUNDAI MOTOR COMPANY, SEOUL (KR); KIA CORPORATION, SEOUL (KR)

(72) Inventors: Keun Soo Kim, Hwaseong-si (KR); Jung Hoon Park, Hwaseong-si (KR); Hyun Soo Jeon, Hwaseong-si (KR); Cheol Lee, Hwaseong-si (KR); Seung Yub Lee, Hwaseong-si (KR)

(73) Assignees: HYUNDAI MOTOR COMPANY, SEOUL (KR); KIA CORPORATION, SEOUL (KR)

(21) Appl. No.: 19/048,133

(22) Filed: Feb. 7, 2025

(30) Foreign Application Priority Data
Sep. 11, 2024 (KR) 10-2024-0124136

(51) Int. Cl. F02M 37/30; B60R 16/033; F02M 31/16; F02M 37/32

(52) U.S. Cl. CPC F02M 37/30; B60R 16/033; F02M 31/16; F02M 37/32

(57) ABSTRACT

An apparatus for controlling a fuel filter heater of a vehicle is provided. The apparatus includes a processor, an input unit connected to the processor, the input unit configured to receive vehicle-related information, and a memory connected to the processor, the memory configured to store setting data. The processor includes a first control unit configured to determine, based on the vehicle-related information and the setting data stored in the memory, a heater-on condition, and to control operation-on for a fuel filter heater of a diesel vehicle when the heater-on condition is satisfied, and a second control unit configured to determine, based on the vehicle-related information input through the input unit and the setting data set in consideration of a cloud point of diesel fuel and stored in the memory, a heater-off condition, and to control operation-off for the fuel filter heater when the heater-off condition is satisfied.

### CROSS-REFERENCE TO RELATED APPLICATION(S)

This application claims benefit of priority to Korean Patent Application No. 10-2024-0124136 filed on Sep. 11, 2024, in the Korean Intellectual Property Office, the disclosure of which is incorporated herein by reference in its entirety.

### TECHNICAL FIELD

The present disclosure relates to an apparatus and method for controlling a fuel filter heater of a vehicle.

### BACKGROUND

In general, diesel fuel used for diesel vehicles may have low-temperature properties in which fluidity is lowered at low temperature. A temperature point at which paraffin is generated due to diesel fuel that decreases in temperature and is blurred is referred to as a cloud point (CP).

In general, when fluidity of diesel fuel is lowered (e.g., at a low temperature), issues may occur. Such issues may include poor starting of an engine, stalling of a vehicle while travelling, or filter bursting occurring due to unremoved wax in the filter. This may cause an error in the settings of operating a heater. Accordingly, a fuel cleanliness-related issue may occur, and an injector defect may occur.

In order to prevent an issue such as filter bursting, when a heater is applied to a fuel filter, the fuel filter heater may be set to have an (e.g., excessively) wide control margin to respond to the global market, such that the heater may be operated in unnecessary sections, resulting in a decrease in fuel efficiency due to (e.g., excessive) power loss.

### SUMMARY

The present disclosure provides an apparatus and method for controlling a fuel filter heater of a vehicle, the apparatus and method capable of controlling, based on a fuel pump current, an operation of a fuel filter heater of a diesel vehicle (e.g., without unnecessary driving) such that the fuel filter heater operates at a temperature lower than or the same as a cloud point.

However, the present disclosure is not limited to the aspects set forth herein, and other aspects set forth herein will be understood from the description below.

According the present disclosure, there is provided an apparatus for controlling a fuel filter heater of a vehicle, the apparatus including a processor, an input unit connected to the processor, the input unit configured to receive vehicle-related information, and a memory connected to the processor, the memory configured to store setting data. The processor may include a first control unit configured to determine, based on the vehicle-related information input through the input unit and the setting data stored in the memory, a heater-on condition, and to control operation-on for a fuel filter heater of a diesel vehicle when the heater-on condition is satisfied, and a second control unit configured to determine, based on the vehicle-related information input through the input unit and the setting data set in consideration of a cloud point of diesel fuel and stored in the memory, a heater-off condition, and to control operation-off for the fuel filter heater when the heater-off condition is satisfied.

The first control unit may include a first comparison unit configured to output a first comparison value by comparing a fuel temperature, a part of the the vehicle-related information, with a heater-on setting temperature included in the setting data, a second comparison unit configured to output a second comparison value by comparing a value of a battery voltage, a part of the vehicle-related information, with a maximum setting value and a minimum setting value included in the setting data, a third comparison unit configured to output a third comparison value by comparing a value of an engine RPM (revolutions per minute), a part of the vehicle-related information, with a maximum setting value and a minimum setting value included in the setting data, and a first logical operation unit configured to provide a heater-on control signal when the heater-on condition is satisfied, based on the first comparison value, the second comparison value, the third comparison value, and IG-on (IG is ignition) information, a part of the vehicle-related information.

The first control unit may include a first comparison unit configured to output a first comparison value having a high level when a fuel temperature, a part of the vehicle-related information, is lower than a heater-on setting temperature included in the setting data, a second comparison unit configured to output a second comparison value having a high level when a value of a battery voltage, a part of the vehicle-related information, is greater than or equal to a maximum setting value included in the setting data, and to (e.g., continuously) maintain the high level of the second comparison value while the value of the battery voltage, greater than or equal to a minimum setting value included in the setting data, is maintained, a third comparison unit configured to output a third comparison value having a high level when a value of an engine RPM, a part of the vehicle-related information, is greater than or equal to a maximum setting value included in the setting data, and to (e.g., continuously) maintain the high level of the third comparison value while the value of the engine RPM, greater than or equal to a minimum setting value included in the setting data, is maintained, and a first logical operation unit configured to provide a heater-on control signal having a high level due to the heater-on condition being satisfied when the first comparison value, the second comparison value, and the third comparison value are (e.g., all) at a high level while IG-on information, a part of the vehicle-related information, is at a high level.

The second control unit may include a fourth comparison unit configured to provide a heater-off control signal when the heater-off condition is satisfied by comparing a fuel pump current value, a part of the vehicle-related information, with a maximum setting value and a minimum setting value, set in consideration of the cloud point of the diesel fuel and included in the setting data.

The second control unit may include a fourth comparison unit configured to output a first heater-off signal, a fourth comparison value, by comparing a fuel pump current value, a part of the vehicle-related information, with a maximum setting value and a minimum setting value, set in consideration of the cloud point of the diesel fuel and included in the setting data, a fifth comparison unit configured to output a second heater-off signal, a fifth comparison value, by comparing a value of a current conversion rate, a part of the vehicle-related information, with a current change rate setting value included in the setting data, and a second logical operation unit configured to provide a heater-off control signal when the heater-off condition is satisfied based on the first heater-off signal and the second heater-off signal.

The second control unit may include a fourth comparison unit configured to output a heater-on control signal having a high level when a fuel pump current value, a part of the vehicle-related information, is greater than or equal to a maximum setting value included in the setting data, and to (e.g., continuously) maintain the high level of the heater-on control signal while the fuel pump current value, greater than or equal to a minimum setting value included in the setting data, is maintained.

The fourth comparison unit may be configured to output a heater-off control signal having a high level due to the heater-off condition being satisfied when the fuel pump current value is less than the minimum setting value while the heater-on control signal having a high level is output.

The second control unit may include a fourth comparison unit configured to maintain and output a heater-on control signal having a high level when a fuel pump current value, a part of the vehicle-related information, is greater than or equal to a maximum setting value included in the setting data, to (e.g., continuously) maintain the high level of the heater-on control signal while the fuel pump current value, greater than or equal to a minimum setting value included in the setting data, is maintained, and to output a first heater-off signal, a fourth comparison value having a high level, due to the heater-off condition being satisfied when the fuel pump current value is less than the minimum setting value while heater-on control signal having a high level is output, a fifth comparison unit configured to output a second heater-off signal, a fifth comparison value having a high level, when a value of a current conversion rate, a part of the vehicle-related information, is less than or equal to a current change rate setting value included in the setting data, and a second logical operation unit configured to provide a heater-off control signal having a high level due to the heater-off condition being satisfied when the first heater-off signal is at a high level and the second heater-off signal is at a high level.

According to the present disclosure, there is provided a method for controlling a fuel filter heater of a vehicle. The method includes a first control step of determining, based on vehicle-related information and setting data, a heater-on condition, and controlling operation-on for a fuel filter heater of a diesel vehicle when the heater-on condition is satisfied, and a second control step of determining, based on the vehicle-related information and the setting data set in consideration of a cloud point of diesel fuel, a heater-off condition, and controlling operation-off for the fuel filter heater when the heater-off condition is satisfied.

The first control step may include a first comparison step of outputting a first comparison value by comparing a fuel temperature, a part of the vehicle-related information, with a heater-on setting temperature included in the setting data, a second comparison step of outputting a second comparison value by comparing a value of a battery voltage, a part of the vehicle-related information, with a maximum setting value and a minimum setting value included in the setting data, a third comparison step of outputting a third comparison value by comparing a value of an engine RPM, a part of the vehicle-related information, with a maximum setting value and a minimum setting value included in the setting data, and a first logical operation step of providing a heater-on control signal when the heater-on condition is satisfied based on the first comparison value, the second comparison value, the third comparison value, and IG-on information, a part of the vehicle-related information.

The first control step may include a first comparison step of outputting a first comparison value having a high level when a fuel temperature, a part of the vehicle-related information, is lower than a heater-on setting temperature included in the setting data, a second comparison step of outputting a second comparison value having a high level when a value of a battery voltage, a part of the vehicle-related information, is greater than or equal to a maximum setting value included in the setting data, and to (e.g., continuously) maintain the high level of the second comparison value while the value of the battery voltage, greater than or equal to a minimum setting value included in the setting data, is maintained, a third comparison step of outputting a third comparison value having a high level when a value of an engine RPM, a part of the vehicle-related information, is greater than or equal to a maximum setting value included in the setting data, and (e.g., continuously) maintaining the high level of the third comparison value while the value of the engine RPM, greater than or equal to a minimum setting value included in the setting data, is maintained, and a first logical operation step of providing a heater-on control signal having a high level due to the heater-on condition being satisfied when the first comparison value, the second comparison value, and the third comparison value are (e.g., all) at a high level while IG-on information, a part of the vehicle-related information, is at a high level.

The second control step may include a fourth comparison step of providing a heater-off control signal when the heater-off condition is satisfied by comparing a fuel pump current value, a part of the vehicle-related information, with a maximum setting value and a minimum setting value, set in consideration of the cloud point of the diesel fuel and included in the setting data.

The second control step may include a fourth comparison step of outputting a first heater-off signal, a fourth comparison value, by comparing a fuel pump current value, a part of the vehicle-related information, with a maximum setting value and a minimum setting value, set in consideration of the cloud point of the diesel fuel and included in the setting data, a fifth comparison step of outputting a second heater-off signal, a fifth comparison value, by comparing a value of a current conversion rate, a part of the vehicle-related information, with a current change rate setting value included in the setting data, and a second logical operation step of providing a heater-off control signal when the heater-off condition is satisfied based on the first heater-off signal and the second heater-off signal.

The second control step may include a fourth comparison step of maintaining and outputting a heater-on control signal having a high level when a fuel pump current value, a part of the vehicle-related information, is greater than or equal to a maximum setting value included in the setting data, and to (e.g., continuously) maintain the high level of the heater-on control signal while the fuel pump current value, greater than or equal to a minimum setting value included in the setting data, is maintained.

The second control step may include a fourth comparison step of outputting a heater-off control signal having a high level due to the heater-off condition being satisfied when the fuel pump current value is less than the minimum setting value while the heater-on control signal having a high level is output.

The second control step may include a fourth comparison step of maintaining and outputting a heater-on control signal having a high level when a fuel pump current value, a part of the vehicle-related information, is greater than or equal to a maximum setting value included in the setting data, (e.g., continuously) maintaining the high level of the heater-on control signal while the fuel pump current value, greater than or equal to a minimum setting value included in the setting data, is maintained, and outputting a first heater-off signal, a fourth comparison value having a high level, due to the heater-off condition being satisfied when the fuel pump current value is less than the minimum setting value while heater-on control signal having a high level is output, a fifth comparison step of outputting a second heater-off signal, a fifth comparison value having a high level, when a value of a current conversion rate, a part of the vehicle-related information, is less than or equal to a current change rate setting value included in the setting data, and a second logical operation step of providing a heater-off control signal having a high level due to the heater-off condition being satisfied when the first heater-off signal is at a high level and the second heater-off signal is at a high level.

In addition, the present disclosure is not limited to the above-described aspects, and other aspects may be additionally understood in the process described herein.

According to example embodiments herein, an operation of a fuel filter heater of a diesel vehicle may be controlled based on a fuel pump current (e.g., without unnecessary driving) such that the fuel filter heater operates at a temperature lower or the same as a cloud point. Accordingly, there may be no unnecessary driving, such that the heater may be (e.g., properly) driven when necessary, thereby reducing power consumption (e.g., due to unnecessary heater operation).

However, the various and beneficial improvements and effects of the present disclosure are not restricted to those set forth herein, and will be understood in the process of describing example embodiments.

### BRIEF DESCRIPTION OF DRAWINGS

The features, and improvements of the present disclosure will be understood from the following detailed description, taken in conjunction with the accompanying drawings, in which:

FIG. 1 is an exemplary diagram of an apparatus for controlling a fuel filter heater of a vehicle according to an example embodiment of the present disclosure;

FIG. 2 is a diagram of a position of a fuel filter of a diesel vehicle;

FIG. 3 is an exemplary diagram of a configuration of a fuel filter heater;

FIG. 4 is a graph of a fuel temperature, a pump current, and heater driving according to a driving method according to the related (e.g., prior) art for a fuel filter heater;

FIG. 5 is an exemplary diagram of a first control operation;

FIG. 6 is an exemplary diagram of a first control operation;

FIG. 7 is an exemplary diagram of a second control operation;

FIG. 8 is another exemplary diagram of a second control operation;

FIG. 9 is an exemplary diagram of the second control operation of FIG. 7;

FIG. 10 is an exemplary diagram of the second control operation of FIG. 8;

FIG. 11 is a flowchart of a method for controlling a fuel filter heater of a vehicle according to an example embodiment of the present disclosure;

FIG. 12 is an exemplary diagram of a first control step;

FIG. 13 is an exemplary diagram of a second control step;

FIG. 14 is another exemplary diagram of a second control step; and

FIG. 15 is a graph of a fuel temperature, a pump current, and heater driving according to the present disclosure.

### DETAILED DESCRIPTION

Hereinafter, example embodiments of the present disclosure will be described with reference to the accompanying drawings. The following detailed description is provided to aid in understanding of a method, a device and/or a system described in the present specification. However, the detailed description is for illustrative purposes, and the present disclosure is not limited thereto.

In describing the example embodiments of the present disclosure, when it is determined that a detailed description of a technology related to the present disclosure may obscure the gist of the present disclosure, the detailed description thereof will be omitted. In addition, terms to be described later are terms defined in consideration of functions in the present disclosure, which may vary depending on intention or custom of a user or operator. Therefore, the definition of these terms may be made based on the contents throughout the present specification. The terminology used herein is for describing example embodiments and is not to be limiting of the example embodiments. As used herein, the singular forms “a,” “an,” and “the” are intended to include the plural forms as well, unless the context indicates otherwise. As used herein, the term “and/or” includes any one and any combination of any two or more of the associated listed items. The terms “comprises” and/or “comprising,” when used in this specification, provide the presence of stated features, integers, steps, operations, elements, components or a combination thereof, but may not preclude the presence or addition of one or more other features, integers, steps, operations, elements, components, and/or groups thereof.

Hereinafter, example embodiments of the present disclosure will be described in more detail with reference to the accompanying drawings.

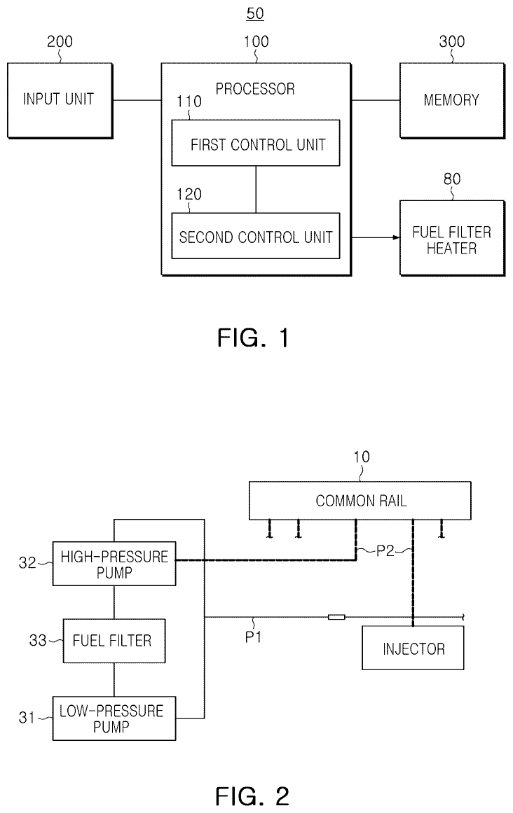

FIG. 1 is an exemplary diagram of an apparatus for controlling a fuel filter heater of a vehicle according to an example embodiment of the present disclosure.

Referring to FIG. 1, a vehicle fuel filter heater control apparatus 50 according to an example embodiment of the present disclosure may include a processor 100, an input unit 200, and a memory 300.

The input unit 200 may be connected to the processor 100, and may receive vehicle-related information CD. For example, the vehicle-related information CD may include at least a fuel temperature obtained at a fuel filter inlet of a diesel vehicle, a battery temperature of the diesel vehicle, an engine RPM of the diesel vehicle, IG-on information of the diesel vehicle, and a fuel pump current of the diesel vehicle.

For example, the vehicle-related information CD may be received from an electronic control unit (ECU) or a vehicle control unit (VCU) of the diesel vehicle, or may be received from a corresponding sensor device, sensing corresponding information, or an information providing device disposed in the diesel vehicle, but the present disclosure is not limited thereto.

For example, the input unit 200 may be connected to other components through an input interface, and may receive vehicle-related information related to the diesel vehicle from other components. In addition, the input unit 200 may include an input device such as a pointing device (e.g., a mouse or a track pad), a keyboard, a touch input device (e.g., a touch pad or a touch screen), a voice or sound input device, various types of sensor devices, and/or an image-capturing device, capable of receiving information.

The memory 300 may be connected to the processor 100, and may store setting data SD. For example, the setting data SD may include at least a heater-on setting temperature for the fuel temperature, a maximum setting value and a minimum setting value for the battery voltage, a maximum setting value and a minimum setting value for the engine RPM, and a maximum setting value and a minimum setting value for the fuel pump current.

For example, the memory 300 according to an example embodiment may include, for example, at least one type of storage medium, such as a flash memory-type memory, a hard disk-type memory, a micro-type memory, or a card-type memory (e.g., a secure digital (SD) card or an eXtream digital (XD) card), a random access memory (RAM), a static RAM (SRM), a read-only memory (RCM), a programmable ROM (PROM), an electrically erasable PROM (EEPROM), a magnetic RAM (MRAM), a magnetic disk, and an optical disk, but the present disclosure is not limited thereto.

The processor 100 may include a first control unit 110 and a second control unit 120 for controlling a fuel filter heater.

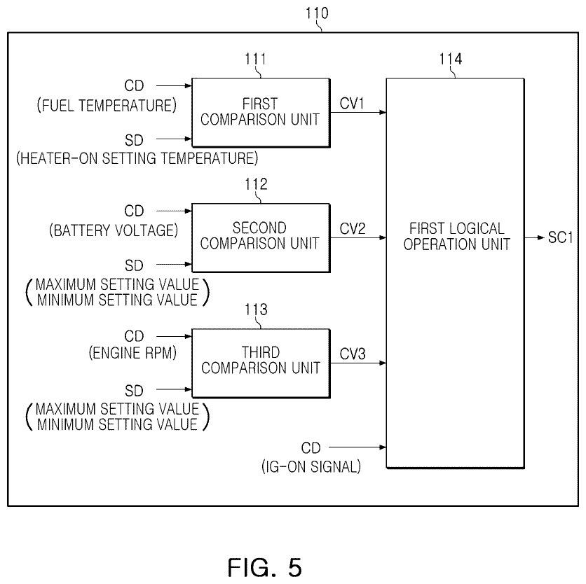

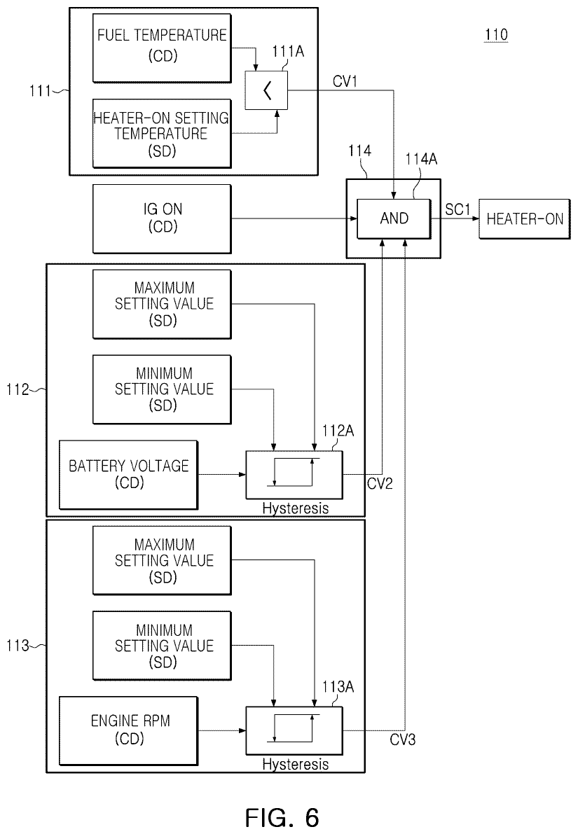

The first control unit 110 may determine, based on the vehicle-related information CD input through the input unit 200 and the setting data SD stored in the memory 300, a heater-on condition, and may control operation-on for the fuel filter heater 80 of the diesel vehicle when the heater-on condition is satisfied. The heater-on condition will be described with reference to FIGS. 5 and 6.

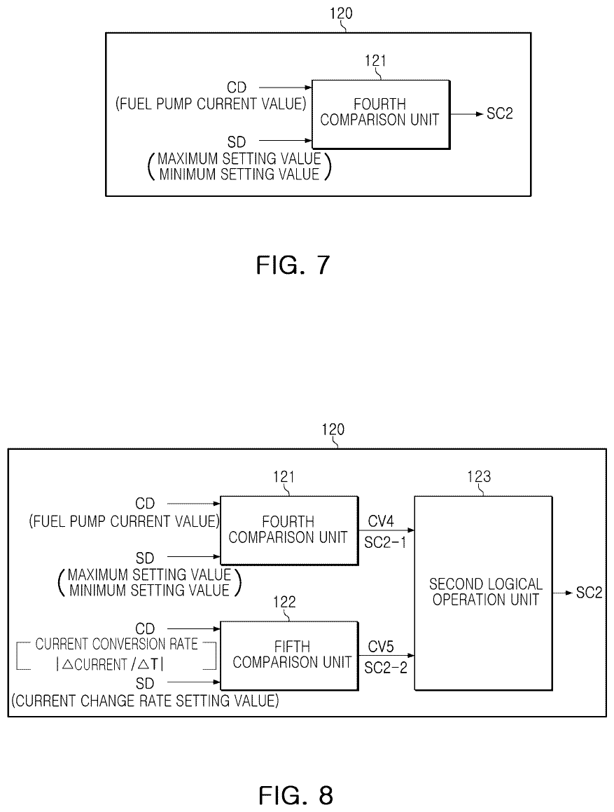

The second control unit 120 may determine, based on the vehicle-related information CD input through the input unit 200 and the setting data SD set in consideration of a cloud point CP of diesel fuel and stored in the memory 300, a heater-off condition, and may control operation-off for the fuel filter heater when the heater-off condition is satisfied. The heater-off condition will be described with reference to FIGS. 7 to 10.

The processor 100 may be, for example, a central processing unit (CPU) or a semiconductor device executing processing on instructions stored in the memory 300. The steps of the method or algorithm described in connection with example embodiments of the present disclosure may be (e.g., directly) implemented by a software module executed by the processor 100 or a combination of the software module and hardware. The software module may reside on a storage medium such as a RAM memory, a flash memory, a ROM memory, an EPROM memory, an EEPROM memory, a register, a hard disk, a solid-state drive (SSD), a detachable disk, or a CD-ROM. For example, the storage medium may be coupled to the processor 100, and the processor 100 may read information from the storage medium and write information into the storage medium. Alternatively, the storage medium may be integrated with the processor 100. The processor 100 and the storage medium may reside in an application-specific integrated circuit (ASIC). The ASIC may reside in a user terminal. Alternatively, the processor 100 and the storage medium may reside as individual components in the user terminal.

In an example embodiment, (e.g., each of) the processor 100, the input unit 200, and the memory 300 may be implemented as an individual processor, or may be implemented as a single integrated processor, but is not limited thereto.

In addition, (e.g., each of) the processor 100, the input unit 200, and the memory 300 may include hardware element(s), software element(s), or a combination thereof in at least one integrated circuit (IC) embedded in the vehicle fuel filter heater control apparatus 50, but the present disclosure is not limited thereto.

In the figures of the present disclosure, repeated descriptions of components having the same reference numeral and the same function may be omitted; however, differences between the drawings may be described.

FIG. 2 is a diagram of a position of a fuel filter of a diesel vehicle.

Referring to FIG. 2, for example, the fuel filter heater 80 of the diesel vehicle illustrated in FIG. 1 may be disposed in a fuel filter 33, and the fuel filter 33 may be disposed in a low-pressure pipe P1 between a low-pressure pump 31 and a high-pressure pump 32.

The high-pressure pump 32 may be connected to a common rail 10 through a high-pressure pipe P2, and the common rail 10 may be connected to an injector 20, injecting high-pressure fuel into a cylinder.

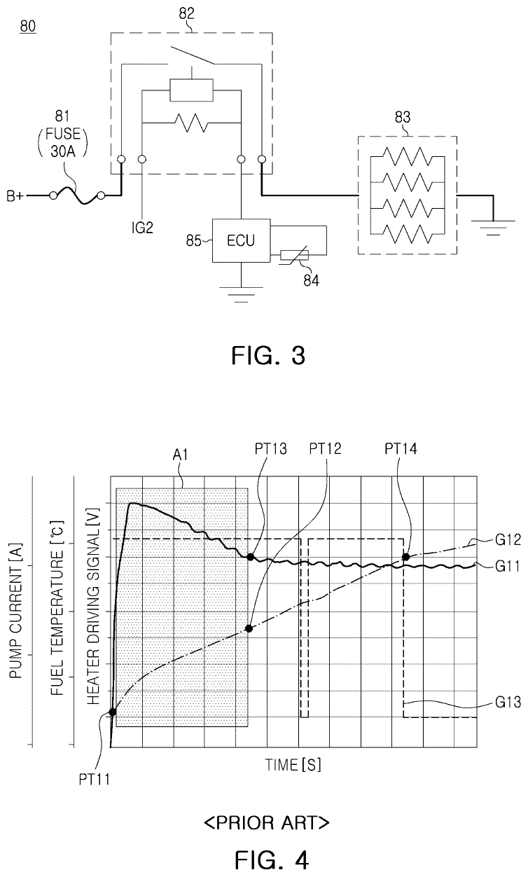

FIG. 3 is an exemplary diagram of a configuration of a fuel filter heater.

Referring to FIG. 3, for example, the fuel filter heater 80 of the diesel vehicle may include a heater power relay 82 and a heater 83 connected to a space between a power source (B+) and the ground, the power relay 82 may be adjusted by an IG2 signal and an ECU controller 85, and a fuel temperature sensor 84 may be connected to the ECU controller 85.

A configuration of the fuel filter heater 80 is an exemplary configuration, and thus the present disclosure is not limited thereto. The heater power relay 82 may be connected to the power source (B+) through a fuse 81.

FIG. 4 is a graph of a fuel temperature, a pump current, and heater driving according to a driving method according to the related (e.g., prior) art for a fuel filter heater.

G11 of FIG. 4 may be a fuel pump current [A], G12 may be a filter inlet fuel temperature [° C.], and G13 may be a heater driving signal [V]. Referring to G11, G12, and G13 according to a driving method of the related art performed based on a fuel temperature, it may be seen that at a point in time of PT11, a fuel temperature is −15° C. by performing a cold start after soaking (e.g., neglecting) is performed at −15° C., at a point in time of PT12, a filter inlet fuel temperature is −3° C., a cloud point temperature of fuel, and at a point in time of PT13, the same as the point in time of PT12, a fuel pump current enters a stable state. At a point in time of PT14, it may be seen that a driving signal of a heater is cut off at a filter inlet fuel temperature of about 8° C., and thus a heater operation is turned off.

Referring to region “A1” of FIG. 4, according to a driving method according to the related art for a fuel filter heater, it may be seen that a high fuel pump current of about 8.5 [A] to 11 [A] is formed due to a decrease in fuel flowability at low temperature.

Accordingly, heater driving may be (e.g., preferably) performed (e.g., only) when a fuel pump current is high at a low temperature of −3° C. or lower, a cloud point temperature. As a result, there may be no need to drive the fuel filter heater 80 at a fuel temperature of −3° C. or higher, a cloud point temperature, and it may be seen that power consumption occurs due to unnecessary driving in the driving method according to the related art.

FIG. 5 is an exemplary diagram of a first control operation.

Referring to FIG. 5, the first control unit 110 may include a first comparison unit 111, a second comparison unit 112, a third comparison unit 113, and a first logical operation unit 114.

The first comparison unit 111 may output a first comparison value CV1 by comparing a fuel temperature, a part of the vehicle-related information CD, with a heater-on setting temperature included in the setting data SD.

The second comparison unit 112 may output a second comparison value CV2 by comparing a value of a battery voltage, a part of the vehicle-related information CD, with a maximum setting value and a minimum setting value included in the setting data SD.

The third comparison unit 113 may output a third comparison value CV3 by comparing a value of an engine RPM, a part of the vehicle-related information CD, with a maximum setting value and a minimum setting value included in the setting data SD.

The first logical operation unit 114 may provide a heater-on control signal SC1 when the heater-on condition is satisfied based on the first comparison value CV1, the second comparison value CV2, the third comparison value CV3, and IG-on information, a part of the vehicle-related information CD.

FIG. 6 is a detailed exemplary diagram of a first control operation.

Referring to FIG. 6, in an example embodiment, a first comparison unit 111 may include a first comparator 111A, and the first comparator 111A may output a first comparison value CV1 having a high level when a fuel temperature, a part of the vehicle-related information CD, is lower than a heater-on setting temperature included in the setting data SD, and may output a first comparison value CV1 having a low level when the fuel temperature is greater than or equal to the heater-on setting temperature (e.g., +3 degrees).

For example, a second comparison unit 112A may include a second comparator 112A, and the second comparator 112A may output a second comparison value CV2 having a high level when a value of a battery voltage, a part of the vehicle-related information CD, is greater than or equal to a maximum setting value included in the setting data SD, or the second comparator 112A may output a second comparison value CV2 having a low level when the value of the battery voltage is less than the maximum setting value (e.g., 10 V). For example, in a state in which the second comparison value CV2 is at a high level, the second comparator 112A may maintain the high level of the second comparison value CV2 while the value of the battery voltage, greater than or equal to a minimum setting value (e.g., 9 V), is maintained. The second comparator 112A may be a hysteresis comparator having hysteresis properties, and for example, may be a Schmitt trigger.

For example, a third comparison unit 113A may include a third comparator 113A, and the third comparator 113A may output a third comparison value CV3 having a high level when a value of an engine RPM, a part of the vehicle-related information CD, is greater than or equal to a maximum setting value included in the setting data SD, or the third comparator 113A may output a third comparison value CV3 having a low level when the value of the engine RPM is less than the maximum setting value (e.g., −10 RPM). For example, in a state in which the third comparison value CV3 is at a high level, the third comparator 113A may maintain the high level of the third comparison value CV3 while the value of the engine RPM, greater than or equal to a minimum setting value (e.g., −20 RPM), is maintained. The third comparator 113A may be a hysteresis comparator having hysteresis properties, and for example, may be a Schmitt trigger.

For example, a first logical operation unit 114 may include a first AND gate 114A. When the first comparison value CV1, the second comparison value CV2, and the third comparison value CV3 are (e.g., all) at a high level and IG-on information, a part of the vehicle-related information CD, is at a high level, the heater-on condition may be satisfied, such that the first AND gate 114A may provide a heater-on control signal SC1 having a high level. Alternatively, when one of the first comparison value CV1, the second comparison value CV2, the third comparison value CV3, and the IG-on information is at a low level, the heater-on condition may not be satisfied, such that the first AND gate 114A may provide a heater-on control signal SC1 having a low level.

FIG. 7 is an exemplary diagram of a second control operation.

Referring to FIG. 7, for example, the second control unit 120 may include a fourth comparison unit 121.

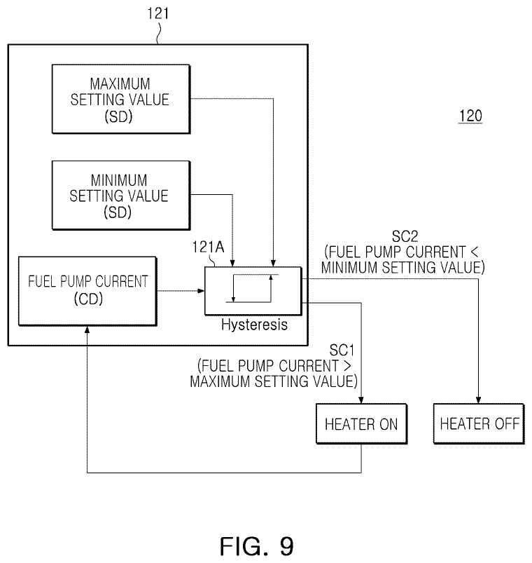

For example, the fourth comparison unit 121 may compare a fuel pump current value, a part of the vehicle-related information CD, with a maximum setting value and a minimum setting value, set in consideration of a cloud point CP of diesel fuel and included in the setting data SD. When the heater-off condition is satisfied, the fourth comparison unit 121 may provide a heater-off control signal SC2. Such a configuration will be described in more detail with reference to FIG. 9.

In the present disclosure, the maximum and minimum setting values for the fuel pump current value may be set in consideration of the cloud point CP of the diesel fuel, such that the cloud point CP may be predicted using the fuel pump current value. As a result, a heater may be driven (e.g., only) at a temperature lower than or the same as the cloud point, thereby (e.g., properly) driving a fuel filter heater without unnecessary configuration.

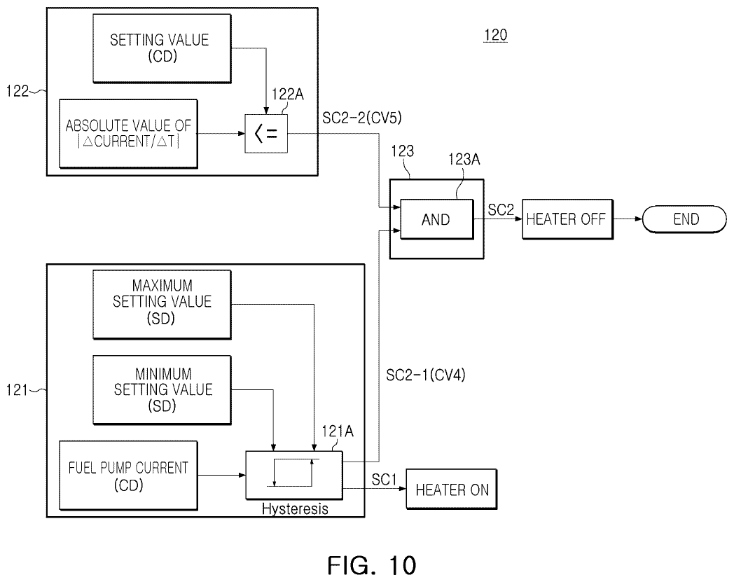

In determining a heater-off time (e.g., a point in time), an example embodiment of determining the heater-off time (e.g., a point in time) in further consideration of a current conversion rate along with a fuel pump current will be described with reference to FIGS. 8 and 10.

FIG. 8 is another exemplary diagram of a second control operation.

Referring to FIG. 8, for example, the second control unit 120 may include a fourth comparison unit 121, a fifth comparison unit 122, and a second logical operation unit 123.

For example, the fourth comparison unit 121 may output a first heater-off signal SC2-1, a fourth comparison value CV4, by comparing the fuel pump current value, a part of the vehicle-related information CD, with the maximum setting value and the minimum setting value, set in consideration of the cloud point CP of the diesel fuel and included in the setting data SD.

The fifth comparison unit 122 may output a second heater-off signal SC2-2, a fifth comparison value CV5 by comparing a value of a current conversion rate, a part of the vehicle-related information CD, with a current change rate setting value included in the setting data SD to. For example, at a low-temperature cold start, a change in a fuel pump current may have a tendency to rise rapidly at the beginning of start-up and then fall sharply again (see FIG. 15). A point in time at which the value of the current conversion rate is less than the current change rate setting value may be used as a condition for determining the heater-off time (e.g., a point in time), as described herein. Such a configuration will be described in more detail with reference to FIG. 10.

In addition, the second logical operation unit 123 may provide a heater-off control signal SC2 when the heater-off condition is satisfied based on the first heater-off signal SC2-1 and the second heater-off signal SC2-2. Such a configuration will be described in more detail with reference to FIG. 10.

FIG. 9 is a detailed exemplary diagram of the second control operation of FIG. 7.

Referring to FIGS. 7 and 9, for example, the fourth comparison unit 121 may include a fourth comparator 121A, and the fourth comparator 121A may maintain and output the heater-on control signal SC1 having a high level when a fuel pump current value, a part of the vehicle-related information CD, is greater than or equal to a maximum setting value (e.g., 11 A) included in the setting data SD.

Alternatively, when the fuel pump current value is less than the maximum setting value (e.g., 11 A), the heater-on condition may not be satisfied, such that the fourth comparator 121A may output a heater on-control signal SC1 having a low level. For example, in a state in which the heater-on control signal SC1 is at a high level, the fourth comparator 121A may (e.g., continuously) maintain the high level of the heater-on control signal SC1 while the fuel pump current value, greater than or equal to a minimum setting value (e.g., 9 A), is maintained.

In addition, while the heater-on control signal SC1 having a high level is output, the heater-off condition may be satisfied when the fuel pump current value is less than the minimum setting value (e.g., 9 A), such that the fourth comparator 121A may output a heater-off control signal SC2 having a high level.

In the present disclosure, the fourth comparator 121A may be a hysteresis comparator having hysteresis properties, and for example, may be a Schmitt trigger.

FIG. 10 is a detailed exemplary diagram of the second control operation of FIG. 8.

Referring to FIGS. 8 and 10, the fourth comparison unit 121 may include, for example, a fourth comparator 121A, and the fourth comparator 121A may maintain and output a heater-on control signal SC1 having a high level when a fuel pump current value is greater than or equal to a maximum setting value (e.g., 11 A). Alternatively, when the fuel pump current value is less than the maximum setting value (e.g., 11 A), a heater-on condition may not be satisfied, such that the fourth comparator 121A may output a heater-on control signal SC1 having a low level. For example, in a state in which the heater-on control signal SC1 is at a high level, the fourth comparator 121A may maintain the high level of the heater-on control signal SC1 while the fuel pump current value, greater than or equal to a minimum setting value (e.g., 9 A), is maintained.

For example, while the heater-on control signal SC1 having a high level is output, the heater-off condition may be satisfied when the fuel pump current value is less than the minimum setting value (e.g., 9 A), such that the fourth comparator 121A may output a first heater-off signal SC2-1, a fourth comparison value CV4 having a high level, In addition, when a value of a current conversion rate (|Δcurrent/ΔT|), a part of the vehicle-related information CD, is less than or equal to a current change rate setting value included in the setting data SD, the fifth comparison unit 122 of the second control unit 120 may output a second heater-off signal SC2-2, a fifth comparison value CV5 having a high level.

In addition, for example, the second logical operation unit 123 may include a second AND gate 123A. When the heater-off signal SC2-1 is at a high level and the second heater-off signal SC2-2 is at a high level, the heater-off condition may be satisfied, such that the second AND gate 123A may provide a heater-off control signal SC2 having a high level.

In an example embodiment, each of a high level and an off level may be logic 1 or logic 0, and the high level and a low level may be voltage levels, and the present disclosure is not limited thereto. In the above example, the vehicle fuel filter heater control apparatus 50 is “active high,” although the present disclosure may be applied to a case in which the vehicle fuel filter heater control apparatus 50 is “active low.”

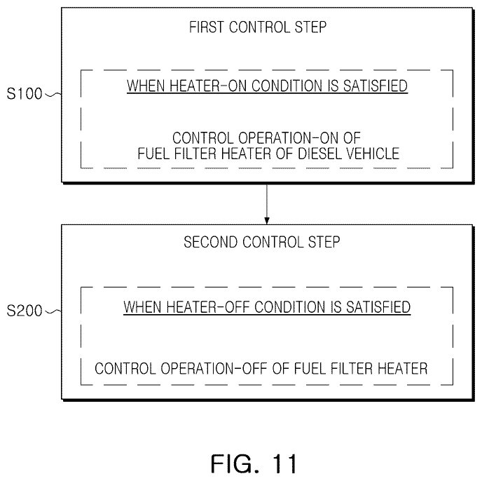

A method for controlling a fuel filter heater of a vehicle will be described with reference to FIGS. 11 to 14. In the present disclosure, a description of a method for controlling a fuel filter heater of a vehicle and a description of an apparatus for controlling a fuel filter heater of a vehicle may complement each other or may be applied in common, unless the descriptions are mutually exclusive. Accordingly, a repeated description may be omitted. Hereinafter, the main processes of the method for controlling a fuel filter heater of a vehicle are described.

FIG. 11 is a flowchart of a method for controlling a fuel filter heater of a vehicle according to another example embodiment of the present disclosure.

Referring to FIGS. 1 and 11, a vehicle fuel filter heater control method according to an example embodiment of the present disclosure may be performed, for example, by the vehicle fuel filter heater control apparatus 50 (see FIG. 1) illustrated in FIG. 1.

Referring to FIG. 11, in an example embodiment, the vehicle fuel filter heater control method may include a first control step S100 and a second control step S200.

In the first control step S100, the fuel filter heater control apparatus 50 (see FIG. 1) may determine, based on vehicle-related information CD and setting data SD, a heater-on condition, and may control operation-on for a fuel filter heater 80 of a diesel vehicle when the heater-on condition is satisfied.

In the second control step S200, the fuel filter heater control apparatus 50 (see FIG. 1) may determine, based on the vehicle-related information CD and the setting data SD set in consideration of a cloud point CP of diesel fuel, a heater-off condition, and may control operation-off for the fuel filter heater when the heater-off condition is satisfied.

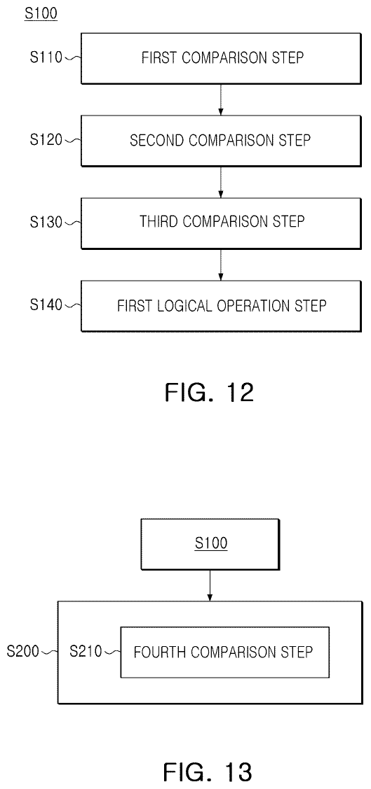

FIG. 12 is an exemplary diagram of a first control step.

Referring to FIG. 12, the first control step S100 may include a first comparison step S110, a second comparison step S120, a third comparison step S130, and a first logical operation step S140.

In the first comparison step S110, the fuel filter heater control apparatus 50 (see FIG. 1) may output a first comparison value CV1 by comparing a fuel temperature, a part of the vehicle-related information CD, with a heater-on setting temperature included in the setting data SD.

In the second comparison step S120, the fuel filter heater control apparatus 50 (see FIG. 1) may output a second comparison value CV2 by comparing a value of a battery voltage, a part of the vehicle-related information CD, with a maximum setting value and a minimum setting value included in the setting data SD.

In the third comparison step S130, the fuel filter heater control apparatus 50 (see FIG. 1) may output a third comparison value CV3 by comparing a value of an engine RPM, a part of the vehicle-related information CD, with a maximum setting value and a minimum setting value included in the setting data SD.

In the first logical operation step S140, the fuel filter heater control apparatus 50 (see FIG. 1) may provide a heater-on control signal SC1 when the heater-on condition is satisfied based on the first comparison value CV1, the second comparison value CV2, the third comparison value CV3, and IG-on information, a part of the vehicle-related information CD.

For example, in the first comparison step S110, the fuel filter heater control apparatus 50 (see FIG. 1) may output a first comparison value CV1 having a high level when a fuel temperature, a part of the vehicle-related information CD, is lower than a heater-on setting temperature (e.g., 3 degrees) included in the setting data SD.

In the second comparison step S120, the fuel filter heater control apparatus 50 (see FIG. 1) may output a second comparison value CV2 having a high level when a value of a battery voltage, a part of the vehicle-related information CD, is greater than or equal to a maximum setting value (e.g., 10 V) included in the setting data SD, and may (e.g., continuously) maintain the high level of the second comparison value CV2 while the value of the battery voltage, greater than or equal to a minimum setting value (e.g., 9 V), is maintained.

In the third comparison step S130, the fuel filter heater control apparatus 50 (see FIG. 1) may output a third comparison value CV3 having a high level when a value of an engine RPM, a part of the vehicle-related information CD, is greater than or equal to a maximum setting value (e.g., −10 RPM) included in the setting data SD, and may (e.g., continuously) maintain the high level of the third comparison value CV3 while the value of the engine RPM, greater than or equal to the minimum setting value (e.g., −20 RPM) included in the setting data SD, is maintained.

In addition, the fuel filter heater control apparatus 50 (see FIG. 1) may provide the heater-on control signal SC1 having a high level when the first comparison value CV1, the second comparison value CV2, and the third comparison value CV3 are (e.g., all) at a high level and the IG-on information, a part of the vehicle-related information CD, is at a high level.

FIG. 13 is an exemplary diagram of a second control step.

Referring to FIG. 13, the second control step S200 may include a fourth comparison step S210.

For example, in the fourth comparison step S210, the fuel filter heater control apparatus 50 (see FIG. 1) may compare a fuel pump current value, a part of the vehicle-related information CD, with a maximum setting value and a minimum setting value, set in consideration of the cloud point CP of the diesel fuel and included in the setting data SD, and may provide a heater-off control signal SC2 when the heater-off condition is satisfied.

For example, in the fourth comparison step S210, the fuel filter heater control apparatus 50 (see FIG. 1) may maintain and output the heater-on control signal SC1 having a high level when a fuel pump current value, a part of the vehicle-related information CD, is greater than or equal to a maximum setting value (e.g., 11 A) included in the setting data SD, and may (e.g., continuously) maintain the high level of the heater-on control signal SC1 while the fuel pump current value, greater than or equal to a minimum setting value (e.g., 9 A) included in the setting data SD, is maintained.

In addition, in the fourth comparison step S210, while the heater-on control signal SC1 having a high level is output, the heater-off condition may be satisfied when the fuel pump current value is less than the minimum setting value (e.g., 9 A), such that the fuel filter heater control apparatus 50 (see FIG. 1) may output a heater-off control signal SC2 having a high level.

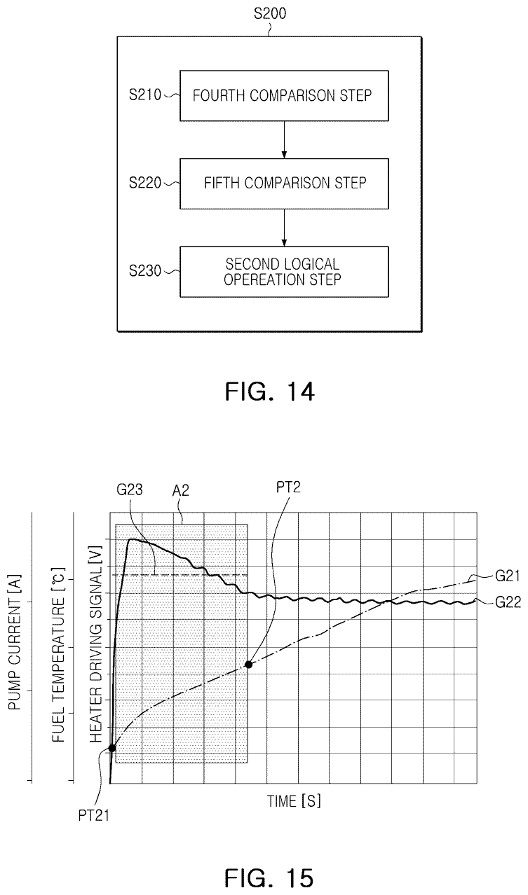

FIG. 14 is another exemplary diagram of a second control step.

Referring to FIG. 14, the second control step S200 may include a fourth comparison step S210, a fifth comparison step S220, and a second logical operation step S230.

For example, in the fourth comparison step S210, the fuel filter heater control apparatus 50 (see FIG. 1) may output a first heater-off signal SC2-1, a fourth comparison value CV4, by comparing a fuel pump current value, a part of the vehicle-related information CD, with a maximum setting value (e.g., 11 A) and a minimum setting value (e.g., 9 A), set in consideration of the cloud point CP of the diesel fuel and included in the setting data SD.

In the fifth comparison step S220, the fuel filter heater control apparatus 50 (see FIG. 1) may output a second heater-off signal SC2-2, a fifth comparison value CV5, by comparing a value of a current conversion rate (|Δcurrent/ΔT|), a part of the vehicle-related information CD, with a current change rate setting value included in the setting data SD.

In addition, in the second logical operation step S230, the fuel filter heater control apparatus 50 (see FIG. 1) may provide a heater-off control signal SC2 when the heater-off condition is satisfied based on the first heater-off signal SC2-1 and the second heater-off signal SC2-2.

FIG. 15 is a graph of a fuel temperature, a pump current, and heater driving according to an example embodiment.

The graph illustrated in FIG. 15 is a graph of results of performing tests under a test condition in which a cold start is performed after soaking is performed at −15° C., and a cloud point at which paraffin is generated is set to −3° C.

In FIG. 15, G21 may be a fuel pump current [A], G22 may be a filter inlet fuel temperature [° C.], and G23 may be a heater driving signal [V]. Referring to G11, G12, and G13 according to the present disclosure considering a cloud point CP and based on a fuel pump current, it may be seen that a point in time of PT21, a fuel temperature is −15° C. by performing a cold start after soaking is performed at −15° C., at a point in time of PT22, a filter inlet fuel temperature is −3° C., a cloud point temperature of fuel, and at a point in time of PT22, a fuel pump current enters a stable state. Accordingly, a heater driving signal may be provided in a section before the point in time of PT22, and a driving signal of a fuel filter heater may be cut off in a section after the point in time of PT22, such that an operation of the fuel filter heater may be turned off.

Referring to region “A2” (e.g., a region at a temperature lower than or the same as a cloud point) of FIG. 15, according to a driving method according to the present disclosure for a fuel filter heater, a fuel filter heater may be driven (e.g., only) in region “A2,” a region having a high fuel pump current, so as to improve fuel fluidity degradation at low temperature.

Accordingly, the fuel filter heater may be driven (e.g., only) in a section at a low temperature lower than or the same as a cloud point setting temperature (e.g., −3° C.) set as a cloud point temperature, and the fuel filter heater may not be driven at a temperature higher than or the same as cloud point setting temperature (e.g., −3° C.). Thus, unnecessary heater driving may be prevented, as compared to the driving method according to the related art. For example, when 500 seconds of unnecessary driving time are reduced in a state in which a heater capacity is 260 watts (W), power consumption may be reduced by about 36 Wh (=260 W*500 seconds/(3600)).

For example, unlike the above-described environment, when a test condition is a condition in which a cold start is performed after soaking is performed at −15° C. and a cloud point CP is −16° C., a heater operation may not be used, such that a reduction of about 70 Wh may be achieved.

While example embodiments have been shown and described above, it will be apparent that modifications and variations could be made without departing from the scope of the present disclosure as defined by the appended claims.

What is claimed is:

1. An apparatus for controlling a fuel filter heater of a vehicle, the apparatus comprising:
a processor;
an input unit connected to the processor, the input unit configured to receive vehicle-related information; and
a memory connected to the processor, the memory configured to store setting data,
wherein the processor includes:
a first control unit configured to determine, based on the vehicle-related information input through the input unit and the setting data stored in the memory, a heater-on condition, and to control operation-on for a fuel filter heater of a diesel vehicle when the heater-on condition is satisfied; and
a second control unit configured to determine, based on the vehicle-related information input through the input unit and the setting data set in consideration of a cloud point of diesel fuel and stored in the memory, a heater-off condition, and to control operation-off for the fuel filter heater when the heater-off condition is satisfied.

2. The apparatus of claim 1, wherein the first control unit includes:
a first comparison unit configured to output a first comparison value by comparing a fuel temperature, a part of the vehicle-related information, with a heater-on setting temperature included in the setting data;
a second comparison unit configured to output a second comparison value by comparing a value of a battery voltage, a part of the vehicle-related information, with a maximum setting value and a minimum setting value included in the setting data;
a third comparison unit configured to output a third comparison value by comparing a value of an engine RPM, a part of the vehicle-related information, with a maximum setting value and a minimum setting value included in the setting data; and
a first logical operation unit configured to provide a heater-on control signal when the heater-on condition is satisfied based on the first comparison value, the second comparison value, the third comparison value, and IG-on information, a part of the vehicle-related information.

3. The apparatus of claim 1, wherein the first control unit includes:
a first comparison unit configured to output a first comparison value having a high level when a fuel temperature, a part of the vehicle-related information, is lower than a heater-on setting temperature included in the setting data;
a second comparison unit configured to output a second comparison value having a high level when a value of a battery voltage, a part of the vehicle-related information, is greater than or equal to a maximum setting value included in the setting data, and to maintain the high level of the second comparison value while the value of the battery voltage, greater than or equal to a minimum setting value included in the setting data, is maintained;
a third comparison unit configured to output a third comparison value having a high level when a value of an engine RPM, a part of the vehicle-related information, is greater than or equal to a maximum setting value included in the setting data, and to maintain the high level of the third comparison value while the value of the engine RPM, greater than or equal to a minimum setting value included in the setting data, is maintained; and
a first logical operation unit configured to provide a heater-on control signal having a high level due to the heater-on condition being satisfied when the first comparison value, the second comparison value, and the third comparison value are at a high level while IG-on information, a part of the vehicle-related information, is at a high level.

4. The apparatus of claim 1, wherein the second control unit includes:
a fourth comparison unit configured to provide a heater-off control signal when the heater-off condition is satisfied by comparing a fuel pump current value, a part of the vehicle-related information, with a maximum setting value and a minimum setting value, set in consideration of the cloud point of the diesel fuel and included in the setting data.

5. The apparatus of claim 1, wherein the second control unit includes:
a fourth comparison unit configured to output a first heater-off signal, a fourth comparison value, by comparing a fuel pump current value, a part of the vehicle-related information, with a maximum setting value and a minimum setting value, set in consideration of the cloud point of the diesel fuel and included in the setting data;
a fifth comparison unit configured to output a second heater-off signal, a fifth comparison value, by comparing a value of a current conversion rate, a part of the vehicle-related information, with a current change rate setting value included in the setting data; and
a second logical operation unit configured to provide a heater-off control signal when the heater-off condition is satisfied based on the first heater-off signal and the second heater-off signal.

6. The apparatus of claim 1, wherein the second control unit includes:
a fourth comparison unit configured to output a heater-on control signal having a high level when a fuel pump current value, a part of the vehicle-related information, is greater than or equal to a maximum setting value included in the setting data, and to maintain the high level of the heater-on control signal while the fuel pump current value, greater than or equal to a minimum setting value included in the setting data, is maintained.

7. The apparatus of claim 6, wherein the fourth comparison unit is configured to output a heater-off control signal having a high level due to the heater-off condition being satisfied when the fuel pump current value is less than the minimum setting value while the heater-on control signal having a high level is output.

8. The apparatus of claim 1, wherein the second control unit includes:
a fourth comparison unit configured to maintain and output a heater-on control signal having a high level when a fuel pump current value, a part of the vehicle-related information, is greater than or equal to a maximum setting value included in the setting data, to maintain the high level of the heater-on control signal while the fuel pump current value, greater than or equal to a minimum setting value included in the setting data, is maintained, and to output a first heater-off signal, a fourth comparison value having a high level, due to the heater-off condition being satisfied when the fuel pump current value is less than the minimum setting value while heater-on control signal having a high level is output;
a fifth comparison unit configured to output a second heater-off signal, a fifth comparison value having a high level, when a value of a current conversion rate, a part of the vehicle-related information, is less than or equal to a current change rate setting value included in the setting data; and
a second logical operation unit configured to provide a heater-off control signal having a high level due to the heater-off condition being satisfied when the first heater-off signal is at a high level and the second heater-off signal is at a high level.

9. A method for controlling a fuel filter heater of a vehicle, the method comprising:
a first control step of determining, based on vehicle-related information and setting data, a heater-on condition, and controlling operation-on for a fuel filter heater of a diesel vehicle when the heater-on condition is satisfied; and
a second control step of determining, based on the vehicle-related information and the setting data set in consideration of a cloud point of diesel fuel, a heater-off condition, and controlling operation-off for the fuel filter heater when the heater-off condition is satisfied.

10. The method of claim 9, wherein the first control step includes:
a first comparison step of outputting a first comparison value by comparing a fuel temperature, a part of the vehicle-related information, with a heater-on setting temperature included in the setting data;
a second comparison step of outputting a second comparison value by comparing a value of a battery voltage, a part of the vehicle-related information, with a maximum setting value and a minimum setting value included in the setting data;
a third comparison step of outputting a third comparison value by comparing a value of an engine RPM, a part of the vehicle-related information, with a maximum setting value and a minimum setting value included in the setting data; and
a first logical operation step of providing a heater-on control signal when the heater-on condition is satisfied based on the first comparison value, the second comparison value, the third comparison value, and IG-on information, a part of the vehicle-related information.

11. The method of claim 9, wherein the first control step includes:
a first comparison step of outputting a first comparison value having a high level when a fuel temperature, a part of the vehicle-related information, is lower than a heater-on setting temperature included in the setting data;
a second comparison step of outputting a second comparison value having a high level when a value of a battery voltage, a part of the vehicle-related information, is greater than or equal to a maximum setting value included in the setting data, and to maintain the high level of the second comparison value while the value of the battery voltage, greater than or equal to a minimum setting value included in the setting data, is maintained;
a third comparison step of outputting a third comparison value having a high level when a value of an engine RPM, a part of the vehicle-related information, is greater than or equal to a maximum setting value included in the setting data, and maintaining the high level of the third comparison value while the value of the engine RPM, greater than or equal to a minimum setting value included in the setting data, is maintained; and
a first logical operation step of providing a heater-on control signal having a high level due to the heater-on condition being satisfied when the first comparison value, the second comparison value, and the third comparison value are at a high level while IG-on information, a part of the vehicle-related information, is at a high level.

12. The method of claim 9, wherein the second control step includes:
a fourth comparison step of providing a heater-off control signal when the heater-off condition is satisfied by comparing a fuel pump current value, a part of the vehicle-related information, with a maximum setting value and a minimum setting value, set in consideration of the cloud point of the diesel fuel and included in the setting data.

13. The method of claim 9, wherein the second control step includes:
a fourth comparison step of outputting a first heater-off signal, a fourth comparison value, by comparing a fuel pump current value, a part of the vehicle-related information, with a maximum setting value and a minimum setting value, set in consideration of the cloud point of the diesel fuel and included in the setting data;
a fifth comparison step of outputting a second heater-off signal, a fifth comparison value, by comparing a value of a current conversion rate, a part of the vehicle-related information, with a current change rate setting value included in the setting data; and
a second logical operation step of providing a heater-off control signal when the heater-off condition is satisfied based on the first heater-off signal and the second heater-off signal.

14. The method of claim 9, the second control step includes:
a fourth comparison step of maintaining and outputting a heater-on control signal having a high level when a fuel pump current value, a part of the vehicle-related information, is greater than or equal to a maximum setting value included in the setting data, and to maintain the high level of the heater-on control signal while the fuel pump current value, greater than or equal to a minimum setting value included in the setting data, is maintained.

15. The method of claim 14, wherein the second control step includes:
a fourth comparison step of outputting a heater-off control signal having a high level due to the heater-off condition being satisfied when the fuel pump current value is less than the minimum setting value while the heater-on control signal having a high level is output.

16. The method of claim 9, wherein the second control step includes:
a fourth comparison step of maintaining and outputting a heater-on control signal having a high level when a fuel pump current value, a part of the vehicle-related information, is greater than or equal to a maximum setting value included in the setting data, maintaining the high level of the heater-on control signal while the fuel pump current value, greater than or equal to a minimum setting value included in the setting data, is maintained, and outputting a first heater-off signal, a fourth comparison value having a high level, due to the heater-off condition being satisfied when the fuel pump current value is less than the minimum setting value while heater-on control signal having a high level is output;
a fifth comparison step of outputting a second heater-off signal, a fifth comparison value having a high level, when a value of a current conversion rate, a part of the vehicle-related information, is less than or equal to a current change rate setting value included in the setting data; and
a second logical operation step of providing a heater-off control signal having a high level due to the heater-off condition being satisfied when the first heater-off signal is at a high level and the second heater-off signal is at a high level.
